(19) United States
(12) Patent Application Publication
(10) Pub. No.: US 2007/0162854 A1
(43) Pub. Date: Jul. 12, 2007

(54) System and Method for Interactive Creation of and Collaboration on Video Stories

(76) Inventor: Dan Kikinis, Saratoga, CA (US)

Correspondence Address: CENTRAL COAST PATENT AGENCY, INC, 3 HANGAR WAY SUITE D, WATSONVILLE, CA, 95076, US

(21) Appl. No.: 11/622,781

(22) Filed: Jan. 12, 2007

Related U.S. Application Data
(60) Provisional application No. 60/759,166, filed on Jan. 12, 2006.

(51) Int. Cl. G06F 3/00; G06T 15/70

(52) U.S. Cl. 715/719; 715/723; 345/473

(57) ABSTRACT

A system for creating videos on a network includes a server with network access for serving source objects and scripts used to generate videos, a data storage facility for storing the source objects, and an application for editing the source objects and scripts used to generate a video. A user operating the application from a connected computing device modifies the generated video scene by scene using available objects and scripts acquired from the server.

### CROSS-REFERENCE TO RELATED APPLICATIONS

The present invention claims priority to a U.S. provisional patent application Ser. No. 60/759,166, entitled System and Method for Interactive Creation of and Collaboration on Video Stories, filed on Jan. 12, 2006, disclosure of which is included herein at least by reference.

### BACKGROUND OF THE INVENTION

1. Field of the Invention

The present invention is in the field of interactive video production and pertains particularly to methods and apparatus for enabling creation of, publishing of, and collaboration on video stories.

2. Discussion of the State of the Art

The field of video gaming has evolved in recent years to include what is known as machinima, which is a portmanteau of machine cinema or machine animation. To create machinima productions, which are typically short video productions; users capture video game video output using a personal computer and utilize provided tools for editing and splicing scenes to render a video production with voice over that uses the characters, scenes and props available from the game.

Users practicing machinema as a production technique are able to render computer-generated imagery (CGI) using real-time, interactive (game) 3D rendering engines from the video game rather than more complex and expensive 3D animation software programs typically used by professionals. 3D rendering engines from first person shooter and role-playing simulation video games are typically used to create the productions in real or near real time using a personal computer (PC).

Generally speaking, machinimas (end productions) are produced using the tools like demo recording, camera angle, level editor, script editor, and so on, and the resources like backgrounds, levels, characters, skins, and so on that are made available in a video game by the game author or author entity. In one application, an interactive video game is available called “The Movies”, in which a studio application is part of the game itself. A successful studio head (user) is successful in the game; he can hire actors to play scenes from the script he or she created. However, the focus of the game is limited to the game of running the studio and the play aspects and not the end product or the created script. Likewise, the feat of capturing the video game output properly still requires a relatively high level of technical skill.

What is needed in the art is a method and system for enabling user-friendly production of, publication of, and collaboration on movies without requiring a high degree of technical skill from the user.

### SUMMARY OF THE INVENTION

The inventor provides a system for creating videos on a network. The system includes a server with network access for serving source objects and scripts used to generate videos, a data storage facility for storing the source objects, and an application for editing the source objects and scripts used to generate a video. A user operating the application from a connected computing device modifies the generated video scene by scene using available objects and scripts acquired from the server.

In one embodiment, the network is the Internet network. In one embodiment, the source objects include props, settings, and characters. Also in one embodiment, the scripts include dialogues and motion scripts. In one embodiment, the server is a video game server.

In one embodiment wherein generated videos are published, the published videos may be collaborated on by one or more persons to generate subsequent different versions. In one embodiment, the application includes an interface for acquiring the source objects and scripts from the server. In another embodiment, the server, the source objects and the scripts are located on a game box connected to the computing device.

In one embodiment, the system further includes an advertisement server having access to the network for serving advertisements to include in generated videos. In one embodiment, the source objects include proprietary items protected by brand name. In a variation of this embodiment, the items include branded settings, branded props, and branded characters. In yet another variation of this embodiment, the items are owned by real actors and are available to use for payment of license fees.

According to another aspect of the present invention, the inventor provides a video editing application for generating a video. The application includes a storyboard for displaying scenes from a video, a work screen for editing a scene from the storyboard, and an interface for acquiring source objects to use in editing the scene. In one embodiment, the source objects include props, settings, characters, and scripts made available to add to the video scene. In this embodiment, the scripts include dialogue scripts and motion scripts. In one embodiment, the interface links the application host machine to a server machine over a network. In a variation of this embodiment, the network is the Internet network, the application host is a personal computer, and the server machine is a game server.

According to another aspect of the present invention, the inventor provides a method for generating a new video from an existing video. The method includes the acts (a) capturing the existing video into a storyboard (b) selecting one or more scenes from the storyboard, (c) editing the scenes by adding available source objects, and (d) rendering the new video. In one aspect of the method in act (a), the video is from a video game. In one aspect, acts (b) and (c) are repeated until the video is completed.

In all aspects, in act (c), editing includes inclusion of one or a combination of a pre-existing source objects and scripts. In one aspect, the source objects include settings, props, and characters and scripts include dialogues and motion scripts. In one aspect of the system including an ad server, ad revenue provides a source of revenue for payment of license fees.

### BRIEF DESCRIPTION OF THE DRAWING FIGURES

FIG. 1 is an architectural overview of an interactive environment for creating, publishing, and collaborating on movies according to an embodiment of the present invention.

FIG. 2 is an exemplary interface of a movie creation application according to an embodiment of the present invention.

FIG. 3 is a process flow chart illustrating acts 300 for authoring a movie according to an embodiment of the present invention.

### DETAILED DESCRIPTION

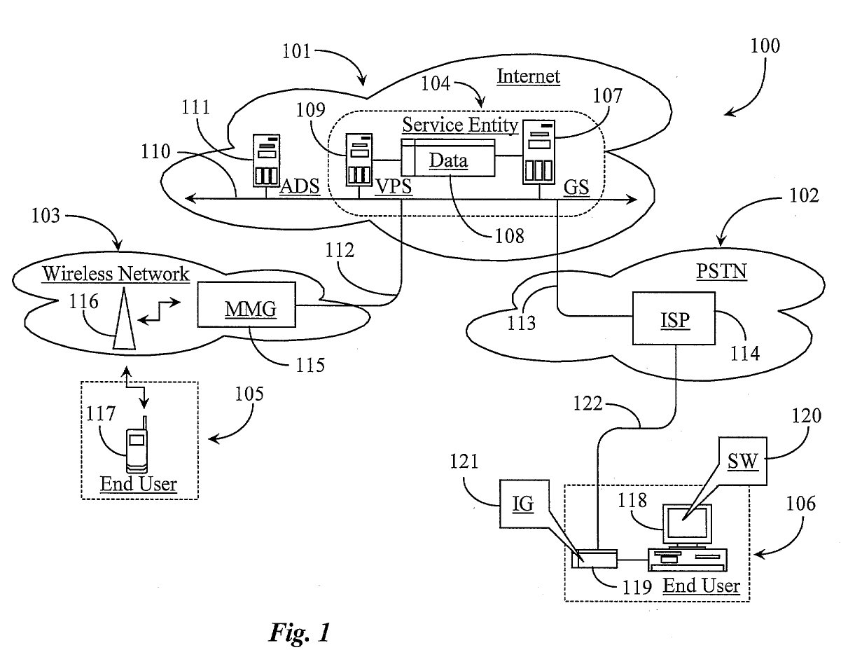

FIG. 1 is an architectural overview of an interactive environment 100 for creating, publishing, and collaborating on movies according to an embodiment of the present invention. Interactive environment 100 includes multiple interactive networks. A wide area network (WAN)) 101 is illustrated as the primary network. WAN 101 may be a public, private, or corporate network including large wireless network segments like a municipal area network (MAN) without departing from the scope of the invention. In this example, network 101 is the Internet network and will be referred to as Internet 101 in this specification.

Internet 101 has a logical Internet backbone 110 extending there through which represents all of the lines equipment and access points that make up the Internet network as a whole. Therefore, there are no geographic limitations to practice of the present invention. Internet 101 includes a service entity 104. Service entity 104 represents a service provider that provides a Web service and Web interface for enabling users to practice the present invention. Service entity 101 may be a corporation that produces and distributes and hosts interactive video games. This is not required in order to practice the invention in some embodiments. Service entity 104 may be an organization that deals strictly from a third party perspective such as a video production and distribution company, or even a small concern set up by one or a group individuals such as a popular movie icons, video game icons or other entities that are well known to the public. Moreover, only one service entity is illustrated in this example, however, there might be many such entities provided to enable practice of the present invention.

Service entity 104 includes a game server (GS) 107 connected to backbone 110. GS 107 is adapted to host interactive gaming and other collaborative activities related to the present invention. GS 107 is accessible to users generally over Internet 101. Service entity 104 includes a video publication server (VPS) 109 connected to backbone 110. VPS 109, among other tasks, is adapted to store and serve videos that were produced according to embodiments of the present invention to the general public accessing the server over Internet 101. Each server GS 107 and VPS 109 has access to a data repository 108 adapted to contain data required to enable service; data required to manage customers and billing; data required to enable game service; and tools required to enable creation of video using pre-existing imagery, animation, and video settings.

Internet 101 includes an advertisement server (ADS) 111 connected to backbone 110. ADS 111 is, in this embodiment, any third party server adapted to serve advertising according to a business relationship with service entity 104. Service entity 104 may also include internal advertisement servers without departing from the spirit and scope of the invention. Internet 101 is accessible generally to the public through other network segments as is known in the art.

In this embodiment, a public switched telephone network (PSTN) 102 is illustrated and a wireless network segment 103 is illustrated as connection networks enabling users to access service entity 104 over Internet 101. For example, an end user domain 106 is illustrated in this example and represents any user accessing Internet 101 through PSTN 102 using an Internet service provider (ISP) 114. ISP 114 represents any ISP, in this case, connected to Internet backbone 110 via an Internet access line 113.

PSTN 102 may be a private network or a corporate network without departing from the scope of the present invention. The inventor chooses the PSTN network because of its high public accessibility and geographic range. Telephone switches, routers and the like are not illustrated in this example but may be assumed present.

End user domain 106 includes a computing device 118, which in this case is a personal computer (PC) connected as a host or as a peripheral to an interactive game box 119. Computing device 118 may be a type of device other than a personal computer without departing from the spirit and scope of the present invention. Any device that can access the Internet, display graphics, and host a version of the software of the present invention can practice the invention in some form.

In this example, game box 119 is connected to ISP 114 via an Internet service line 122. ISP, in turn is connected to backbone 110 via access line 113. Game box 119 contains all of the components and software for enabling a user to play interactive and/or non-interactive video games using PC 118 as a play station. Game box 119 has an instance of interactive gaming (IG) software 121 provided thereto and executable thereon by the user operating PC 118. In one embodiment of the invention, game box 119 is not absolutely required in order to practice the present invention. In this example, game box 119 is illustrated to include embodiments where high-end gaming capabilities are desired. All of the gaming software and hardware capabilities may also be contained solely in PC 118 without departing from the spirit and scope of the invention.

PC 118 has software (SW) 120 installed thereon and executable there from. SW 120 is adapted as a user-friendly movie creation, editing and publishing suite that enables a user to produce high-quality video shorts or moderate productions using pre-existing settings, props and characters. SW 120 may be provided with a video game or may be provided on some removable media that can be accessed by PC 118 for the purpose of running the SW from the media or to access the SW on the media and install the SW on PC 118. In one embodiment, SW 120 may be accessed as a download from GS 107 or from VPS 109.

SW 120 enables a user to create a storyboard by capturing output from a video game or some other production. The user may then generate a movie by cutting and pasting scenes and by selecting adding background, props, actors' motions and actor's or voice over dialogue to those scenes. The final result can be rendered as a video production with voice over that can then be published using SW 120.

In one embodiment of the present invention, a user operating PC 118 aided by SW 120 may access a game locally or from GS 107 and play the game while capturing the game output onto a storyboard. The user may access pre-existing props, characters, character motions or animations, background settings, and so on in a 3-dimensional environment to produce the video production. In one embodiment, the pre-existing video objects are stored in data repository 108 and are accessible to a user through GS 107 or through VPS 109.

An end user domain 105 is illustrated in this example. End user domain 105 includes an Internet capable telephone 117 that has the capability of accessing service entity 104. Telephone 117 may be a third generation (3G) cellular device, or some other communication device operated as a handheld device. Telephone 117 may be an Internet protocol (IP) phone operated through a Centrex service.

In this example, telephone 117 connects wirelessly to network 103 via cell tower 116 and has access to Internet 101 through a multimedia gateway (MMG) 115 and Internet access line 112. Access line 112 is connected to backbone 110. More appropriately, end user 105 may be an end consumer, for example, that is enabled to download and view video productions generated by other users such as by user 106. End user 105 represents a dedicated user that, in this specific example, does not have the capability of producing video but may participate in a video distribution chain as a consumer of video. Likewise, other electronics products such as MP3™ players, Ipods™, San DiSc™ music players and the like can be used as peripherals connected to a PC to download consume video productions. The network capabilities of telephone 117 obfuscate the need for a host PC for downloading and viewing videos generated by other users.

In general practice of the present invention, a user operating PC 118 may connect online to service entity 104 for the purpose of accessing games or sets of computer graphics data for creating a movie production. In one embodiment the user may capture the output of an interactive game played while online with the aid of GS 107. In another embodiment, the game may be played locally and the output captured while offline. In still another embodiment, the fodder (computer graphics) for creating a movie is not necessarily part of a game, but or reserved in data storage and served to the user upon request.

Using SW 120, the user generates a video production that may then be published if the user so desires. In one embodiment, publishing the work is a requirement of a license agreement between the user and service entity 104. The user may then publish the finished production to VPS 109 from which it is then available to end users or consumers like end user domain 105. In one embodiment of the present invention, the author of a video production published to and available through VPS 109 may also include a scripting file along with the stock video file. The scripting file may contain tools and links to Web-based objects like virtual reality markup language (VRML) files, X3D files, 3DXML files, and other popular 3D languages. The scripting file is supported by and understood by SW 120.

An authorized creator (user who has purchased a license) can modify video productions and can potentially benefit from such modifications. For example, each time a production is re-published, it may retain a version and may include author's notes describing and quantifying the modifications made to the original version of the production. For example, if a production picks up a new character and several new scenes, then the new creator could license those graphics. For example, if the publication modification made it more popular and it was presented in an economically conducive marketplace, the creator could retain a portion of the royalties deemed equal to the user's contributions that made the publication successful.

Advertising can be integrated into publications, like commercials for example. In one embodiment, advertising may be overlaid on specific scenes in the production. In another embodiment, available props include brand name items contributed by manufacturers, retailers, or other businesses. For example, a resort in Hawaii may be provided as a setting for a movie and selected for a backdrop for a popular production. The benefit of this type of advertising is clear. The more people consuming the production, the more people become aware of the resort name and location. Still further, popular movie icons or other celebrities might provide uploaded body and/or motion scans and other animated imagery and static props for use in generated movies.

Revenue generated by successful productions can be originally based on advertising and creators that purchase licenses to modify productions. As revenue is generated in a commercial environment, the hosting entity may share revenue with particularly successful creators by paying out royalties to those creators for their contributions. Likewise revenue might be shared with certain real actors whose likeness is licensed through the creative process in using props scans, dialogues or the like made available for license by those real actors.

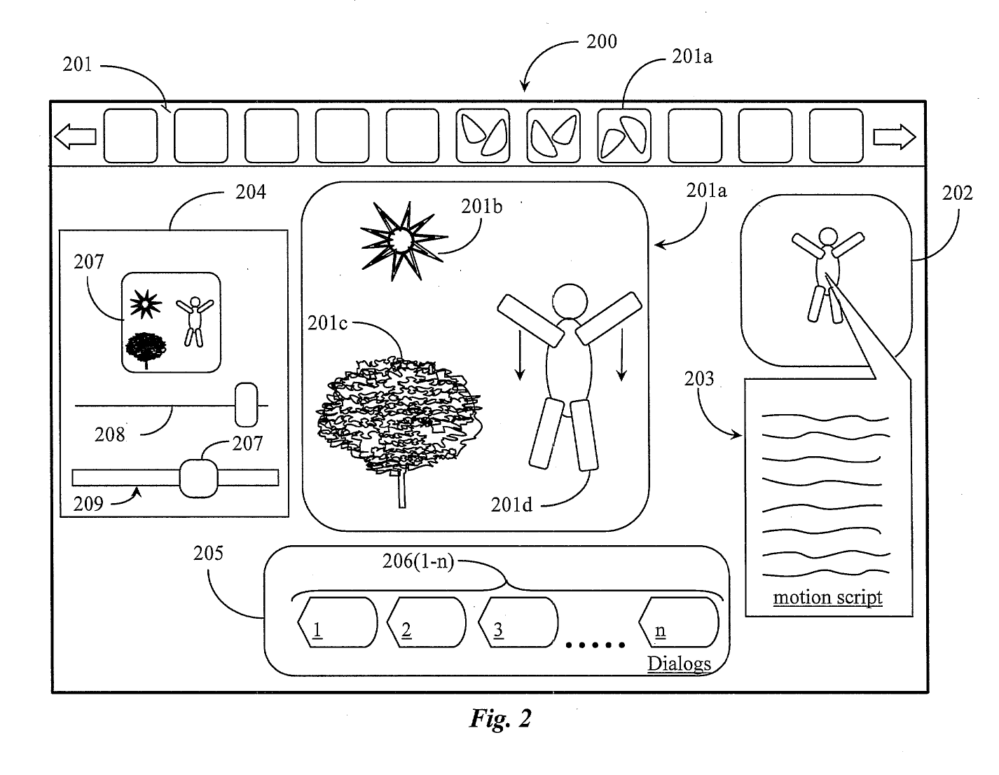

FIG. 2 is an exemplary interface 200 of a movie creation application (SW 120) according to an embodiment of the present invention. Interface 200 may be assumed to be a user interface of SW 120 described further above with reference to FIG. 1. Interface 200 contains a storyboard section 201 wherein a video capture technique renders the frames of a video output used as a reference for creating a new production.

Storyboard 201 contains scenes from captured video output including scene 201a selected by the user for edit. It is important to note herein that a scene may be one or more stills captured from video output depending on settings applied. In this example, the selected scene 201 a is illustrated enlarged within the work area of interface 200. Enlarged scene 201a can be manipulated in several ways. For example, scene 2012a may be depicted according to multiple camera angles such as top view, side view, perspective, or virtual camera view. The user may select a setting, indoors or outdoors from pre-existing settings stored for the purpose. In this case, a user has selected an outdoor setting including tree 201c and sun 201b. The user may delete existing props within scene 201 a in favor of replacing those props with new props and so on.

In scene 201a, the user has also added an actor 201d. Actor 201d may be one of any available characters either provided with the original production, or made available to add to the production. The character and its full range of motions are already known to the system and there are multiple selectable options. In this case, the user has actor 201d selected and therefore it appears alone in a secondary screen 202. If some other object were selected in screen 201a, it too would appear in a dedicated secondary screen like screen 202. Screen 202 is adapted to enable the user to work solely on one object that appears in scene 201a with the ability to assign attributes to the object such as animation, motion, and dialogue.

In one embodiment, a user leveraging the appropriate markup language tools can draw motion vectors to assign motion to character 201 d within its acceptable range of motion. In screen 202, a motion script 203 is illustrated that describes the motion or animation applied to the character by the user. In one embodiment, the user cannot create or is not authorized to create new motion scripts, but must select an available script from a pool of scripts available for the character. Motion can also be applied to sun 201a such as direction of movement, or to tree 201 c, such as wind blown animation. The ranges, speeds and intensity of like motion scripts can be modified using scripting tools or variants may be provided in a pool of available animations. The granularity of object 201d, for example, may be obtained to an extent that there may be several motion options for various parts of the objects body. For example, legs, eyes, feet, hands, arms, fingers, waist, and so on may be independently controlled in one embodiment.

In this example, a user may select a dialogue from a pool of dialogue sets 206 (1−n) made available for selection through a dialogue set window 205. In one embodiment, the user may also, if desired, create new dialogue sets by combining existing sets with modifications made to create completely new dialogues in the generic voice of the character. In still another embodiment, a user may be able to and authorized to create and to add dialogue done in the user's own voice. This feature may be important for adding talent to a production wherein the user is a known impersonator or voice specialist. Voice dialogues that lend to the popularity of a production may produce royalties for the creator.

The system as a whole may use versioning and author information as a way to track individual contributions to a video production. In one embodiment, certain contributions that appear key to the success of the production or that may be largely contributive to its success may not be licensed for modification such as, perhaps a hit character that has proven intensely popular in previous productions. In this way, the service entity is able to control to what existing features of the production can or cannot be edited. Likewise, certain important branded objects contributed from third parties for advertisement value may, according to contract, not be edited. The service entity may write a set of rules for each project that may evolve during the run of the project so the project may evolve successfully without ruin. Likewise, a service entity may retain control over publishing to an extent as to not publish material that was reckless, distasteful, obscene, and so on. As well, a rating system may be devised for certain projects where, according to added content, the rating for audience viewing may be changed.

A screen 204 is provided within interface 200 and is adapted to show the story within the finished scene 201a, illustrated here as scene 207. Scene 207 is also shown in its relational position to the total story 209. When a user has cut, edited, and positioned all of the scenes for a video production with dialogue, the user may save the production and then view the production using a generic viewer or one supplied by the service entity (not illustrated) which may be part of SW 120 in addition to interface 200. If a user is satisfied with the content and quality, the user may upload the production to a publishing Web site like VPS 109. The published package will consist of two files, the movie file and the movie script file. An end user may view the movie with any supported multimedia viewer. However, only a user who has purchased a license to be an author, or is otherwise authorized to edit published productions can download the movie script file. Such as author will have access to all of the tools that the creator had access to, namely SW 120 described above.

In one embodiment, the original source for computer generated graphics for a production is the service entity storing the original production and the graphics originally created for the production. For example, if the source for a project is an established video game, then the original graphics and scripts for that game may be made available to the creators that may modify the production. In one case, those graphics may be sent along with a video game purchased by one who is licensed to generate new video productions from the game. Also in this case, any new computer generated images (CGIs) and dialogues created and published in subsequent video productions rendered from the game may be licensed for use in creating more versions. In this way, the cache of options increases each time a specific video is reworked or modified to include new features thus becoming the newest version of the production.

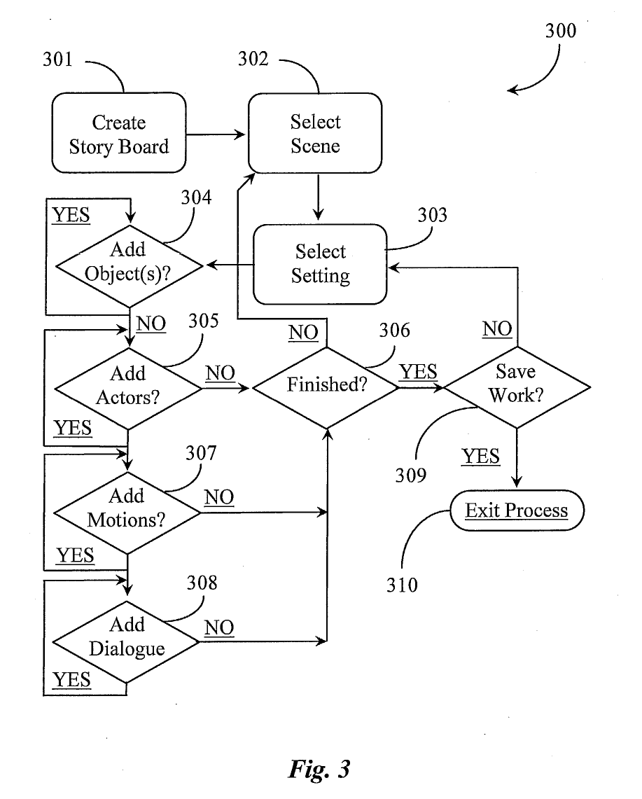

FIG. 3 is a process flow chart illustrating acts 300 for authoring a movie according to an embodiment of the present invention. In act 301, a storyboard is created. Act 301 may occur as a result of capturing the output of a video game or some other production. In act 302, a user selects a scene from the storyboard created in act 301.

In act 303, the user may select a setting from a pool of available settings. The setting may be an indoor setting or an outdoor setting. For example, a cityscape may be the setting selected such as downtown Indianapolis, or some popular section of Miami. There may be several different views of a same setting that may include 3-dimensional views.

In act 304, the user decides whether to add objects to the setting. Objects may include any available props like cars, trucks, trees, shrubs, or the like. If in act 304, the user adds objects, the process may loop until the user decides that enough objects have been added. Or the user may decide not to add any objects to the scene. In either case, the process moves to act 305 where the user decides whether to add actors or characters to the scene. Actors or characters may be selected from a pool of actors and characters made available to the user. If the user decides that there will be no characters added to the scene, then in act 306 the user may decide if he or she is finished working on the production. If the user is not finished working on the production, then the user may select another scene to work on back at act 302 and the process loops back. If the user is finished working on the production then at act 309 the user may decide whether to save the production. If the user decides to save the production at act 309, then the user may exit the process at act 310.

If at act 305, the user decides to add actors or characters, then act 305 may be repeated for the number of characters or actors added. If one or more actors or characters are added in act 305, the user will decide in act 307 whether to add motions to those actors or characters added in act 305. It is noted here that the process order is not strict. For example a user may add one actor and then assign one or more motions to that actor before adding another actor to the scene. Motions may be selected from a pool of available motion scripts. In one embodiment, a user may create motions by combining existing motions. In another embodiment, a user may create new motions using vector graphics if the software supports that feature.

In act 307, if the user decides not to add any motions to the one or more actors or characters, then the process may move back to act 306 where the user decides if he or she is finished working on the production. If the user adds motions to the actors or characters, then in act 308, the user may decide whether to add dialogue to those added actors or characters. If the user decides to add dialogue in act 308 then the process may loop back until all of the dialogue is added. It is noted that the user may select dialogues from pre-existing dialogue sets. In one embodiment, the user may create dialogues by combining existing dialogues and editing those dialogues if the software supports that feature. In another embodiment, the user may also be enabled to create dialogue with voice over techniques.

It is important to note herein that a user may add dialogue to a scene even if the user did not add actors or motions to the scene. Moreover, a user may add motions to objects as well as actors. Therefore, the order of acts 300 is not limited to the order presented; rather the order presented is just one possible sequence of a flexible process. In all events of practicing the process, the user may decide he or she is finished working on the project in act 306. The user may save his or her work in act 309 and exit the process at act 310. It is important to note herein that the user may view the production up to date after saving the movie file and scripting file, and then may decide to resume work on the production generally following the process described. If the user ultimately determines that the project is complete, the user may save and publish the work to a publication Web site like VPS 109 described further above.

It will be apparent to one with skill in the art that acts 300 may be performed out of the presented order without departing from the spirit and scope of the present invention. Moreover, some of the acts illustrated may be skipped or may not be performed at all depending on the desire of the user and the nature of the creative process. For example, one or more scenes of a production may not have actors or props but may have dialogue in the form of a narrative for example. Another scene may include one or more actors, but no motions attributed to those actors, etc. Some scenes may be included in the new production without editing them at all. For example, a production may be focused simply on changing an ending. In this case, only the scenes depicting the original ending would be selected and modified.

Any user having a PC that is capable of Internet access may practice the methods and apparatus of the present invention. In one embodiment, the producer of the original work provides all of the computer-generated imagery, dialogue scripts, and motion scripts that users are licensed to edit. The methods and apparatus of the present invention should be afforded the broadest possible interpretation under examination. The spirit and scope of the present invention shall be limited only by the claims that follow.

What is claimed is:

1. A system for creating videos on a network comprising;
a server with network access for serving source objects and scripts used to generate videos;
a data storage facility for storing the source objects; and
an application for editing the source objects and scripts used to generate a video;
characterized in that a user operating the application from a connected computing device modifies the generated video scene by scene using available objects and scripts acquired from the server.

2. The system of claim 1, wherein the network is the Internet network.

3. The system of claim 1, wherein the source objects include props, settings, and characters.

4. The system of claim 1, wherein the scripts include dialogues and motion scripts.

5. The system of claim 1, wherein the server is a video game server.

6. The system of claim 1, wherein generated videos are published and wherein the published videos may be collaborated on by one or more persons to generate subsequent different versions.

7. The system of claim 1, wherein the application includes an interface for acquiring the source objects and scripts from the server.

8. The system of claim 1, wherein the server, the source objects and the scripts are located on a game box connected to the computing device.

9. The system of claim 1, further including an advertisement server having access to the network for serving advertisements to include in generated videos.

10. The system of claim 1, wherein the source objects include proprietary items protected by brand name.

11. The system of claim 10 wherein the items include branded settings, branded props, and branded characters.

12. The system of claim 11, wherein the items are owned by real actors and are available to use for payment of license fees.

13. A video editing application for generating a video comprising:
a storyboard for displaying scenes from a video;
a work screen for editing a scene from the storyboard; and
an interface for acquiring source objects to use in editing the scene.

14. The application of claim 13, wherein the source objects include props, settings, characters, and scripts made available to add to the video scene.

15. The application of claim 13, wherein the scripts include dialogue scripts and motion scripts.

16. The application of claim 13, wherein the interface links the application host machine to a server machine over a network.

17. The application of claim 14, wherein the network is the Internet network, the application host is a personal computer, and the server machine is a game server.

18. A method for generating a new video from an existing video comprising the acts:
(a) capturing the existing video into a storyboard;
(b) selecting one or more scenes from the storyboard;
(c) editing the scenes by adding available source objects; and
(d) rendering the new video.

19. The method of claim 18, wherein in act (a), the video is from a video game.

20. The method of claim 18, wherein in acts (b) and (c) are repeated until the video is completed.

21. The method of claim 18, wherein in act (c), editing includes inclusion of one or a combination of a pre-existing source objects and scripts.

22. The method of claim 21, wherein the source objects include settings, props, and characters and scripts include dialogues and motion scripts.

23. The system of claim 9, wherein ad revenue provides a source of revenue for payment of license fees.
